(19) United States
(12) Patent Application Publication
(10) Pub. No.: US 2014/0188683 A1
(43) Pub. Date: Jul. 3, 2014

(54) SYSTEMS AND METHODS FOR IMPLEMENTING TRADING AND GLOBAL MATCHING BASED ON BROKER SUGGESTED PRICES

(71) Applicant: Francesco Cicero, London (GB)

(72) Inventor: Francesco Cicero, London (GB)

(21) Appl. No.: 13/826,963

(22) Filed: Mar. 14, 2013

Related U.S. Application Data
(60) Provisional application No. 61/748,092, filed on Jan. 1, 2013.

(51) Int. Cl. G06Q 40/04

(52) U.S. Cl. CPC G06Q 40/04
USPC 705/37

(57) ABSTRACT

Systems and methods for implementing trading and matching are provided. A system includes a database configured to store financial instrument information and a memory configured to store execution instructions. A processor executes the instructions. The processor may initiate a trading session. The processor may receive instructions. The instructions may include either a buy or sell position and a price. The buy or sell position may not be for display to other broker clients. In response to a trade command from one of a plurality of other broker clients, the instructions may require sending an electronic notification to the first broker client that one of the plurality of broker clients has submitted a counter order that is capable of executing a trade with the first broker's buy or sell position.

### CROSS REFERENCE TO RELATED APPLICATION

This application is a non-provisional of U.S. Provisional Patent Application No. 61/748,092, filed Nov. 30, 2012, entitled “SYSTEMS AND METHODS FOR IMPLEMENTING TRADING AND GLOBAL MATCHING BASED ON BROKER SUGGESTED PRICES,” which is incorporated by reference herein in its entirety.

### BACKGROUND OF THE INVENTION

This invention relates to electronic trading systems and methods. Specifically, this invention relates to electronic trading systems and methods of trading that may preferably be implemented without interrupting regular market activity.

### SUMMARY OF THE DISCLOSURE

It is an object of the invention to implement one or more trading states based on broker-suggested price(s). For the purposes of this application, a broker may be understood to refer to an entity that may place trades on a trading system for others, may maintain the existence of an electronic trading system as a viable platform for others to trade, or may perform other actions, on behalf of other entities, to further trading.

Certain embodiments of a trading state may support trading independent of regular market activity. For the purposes of this application, the term broker-suggested price (hereinafter “BSP”) or, in the alternative, broker-suggested order (hereinafter “BSO”), may be understood to refer to the entry of a suggested bid, a suggested offer, or a suggested, albeit theoretical, trade, for display to a market, that does not reflect a tradable interest. Rather, a BSP or BSO represents a possible, and possibly even likely, trading position which is, however, not executable.

One characteristic of a bid that is input in response to a BSP may include a bid that may be acted on by a counterparty, but that such action does not result in an executed trade. In such an example, the action by the counterparty, which could be a trader or represented by a broker, or just a trader him or herself, may, or may not, be posted on an electronic trading platform. Such posting may allow for viewing, and/or action, by other entities—e.g., traders. Such posting may allow for action in response to the posting. Such action may include at least one of the other entities hitting a posted bid, or lifting a posted offer.

For the purposes of this application, a posted price (in the form of a bid or offer) may indicate that an entity has agreed to buy or sell a volume of an interest. In some embodiments, when a first trader has submitted a bid or offer at a BSP, the first trader may have requested, either by a default setting or a specific request, that the bid or offer remains unposted—i.e., that the bid or offer is not viewable, and/or actionable, by other entities.

Thereafter, (or prior thereto) another trader may submit a counter order, such as an offer or a bid, respectively. The trader who submitted the counter order may have not requested that the offer or bid remain unposted. Following the detection of the existence of the posted counter order, certain embodiments may notify the trader associated with the unposted order that there is a posted counter order.

The trader associated with the unposted order may either accept the counter order, and allow a trade to be executed with the posted offer or posted bid, respectively.

In certain embodiments, the trader associated with the unposted bid or offer may, alternatively, be presented with a choice—either allow the trade to be consummated or have his unposted bid or unposted offer removed from the system.

The trader that posted the bid in response to the BSP may then accept, or refuse, the response of the counterparty to the bid.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus in accordance with the principles of the invention;

FIG. 2 shows a first graphical user interface (“GUI”) for use with systems and methods according to the invention;

FIG. 3 shows a second GUI for use with systems and methods according to the invention;

FIG. 4 shows a third GUI for use with systems and methods according to the invention;

FIG. 5 shows a fourth GUI for use with systems and methods according to the invention;

FIG. 6 shows a fifth GUI for use with systems and methods according to the invention; and

FIG. 7 shows a sixth GUI for use with systems and methods according to the invention.

### DETAILED DESCRIPTION OF THE DISCLOSURE

In some embodiments of the invention, sessions involving broker-suggested prices may be initiated and managed by brokers in a price sheet via a new workspace column. For the purposes of this application, a price sheet may be understood to be a spreadsheet including a bid column(s) and an offer column(s) for one or more interests. A session may be understood to be a period of time within which investors may execute a buy or sell of a volume of an interest. For the purpose of this application, a workspace column for use with a BSP may be understood to be an additional column on the price sheet which shows broker-suggested prices.

Such a new workspace column may be used to control the session. Multiple BSP sessions may be maintained for different interests. The identity of each individual interest may be specified by the broker when initiating the session.

In some embodiments, only brokers may be permitted to submit, view, and manage suggested-price orders. As stated above, for the purposes of this disclosure, the term “broker-suggested price” may be understood to refer to a price suggested by a broker that does not reflect a tradable market position.

In some embodiments, only traders may be permitted to submit, view, and manage suggested-price orders. Thus, a suggested-order may be created and updated only by a trader. In some embodiments, only selected traders may be allowed to submit, view and manage suggested orders.

In some embodiments, both brokers and traders may be permitted to submit, view, and manage suggested-price orders. Thus, a suggested-price order may be created and updated by brokers and traders. In some embodiments, only selected brokers and/or selected traders may be allowed to submit, view, and manage suggested price-orders.

In some embodiments, buyers and sellers in the session involving a suggested price may be instantly matched based on time priority.

While a session involving a suggested price is in progress on an interest, orders may be entered into the market. In certain embodiments, the original suggested order may eventually mature, or manually be changed, into a posted order. In such embodiments or other embodiments all or some of the non-traded orders may remain in the system as non-posted orders until such time as the non-posted orders get executed. In the event that a market order crosses with a BSO,—i.e., a market bid is higher than a BSO or a market offer is lower than a BSO, the BSS may automatically end for all users and all outstanding orders may be cancelled.

Brokers that had outstanding suggested orders that crossed with the market order may receive a trade execution popup, which notifies the crossed trader of the trading opportunity and allows the trader to hit or lift the market order directly via the trade execution popup.

In the event that there is an executed, posted trade in the market on an interest for which a session involving a suggested price is in progress, the session may end for all users.

When a suggested price order is specified for an interest, the suggested price order may apply to all instances of the interest across all workspaces—i.e., across all accessible areas that support the trading of the interest. The specified level may preferably be visible to all users that have access to the workspace.

If there are any active sessions involving a suggested price on any interests in a predetermined workspace, the suggested price level may be populated with the active suggested price level when a suggested price order column is added to the workspace. It should be noted, however, that the embodiments relating to unposted orders may be limited to certain interests and may not be applicable to certain interests.

When a broker submits a suggested order for session initiation, the suggested order price may be validated based on the following rules:

The suggested price may be subject to the same validation rules—e.g., rules that determine, based on current market conditions, whether a given trade price is not artificially manipulated—as a price on a conventional market order. Such validation rules may include price variance checks, price tick checks, and/or minimum and maximum price checks.

When the interest is unquoted, any suggested price that passes the standard price validation rules for the interest may be accepted.

When the related interest is quoted in the regular market as either a one-way price—i.e., a bid or offer, or a two-way price—i.e., as a bid and an offer, the BSP level should preferably be somewhere within the quoted bid-offer range, but need not be the exact middle of the range.

The BSP may be deemed to be ‘out of range’ when it equals or crosses either the highest live bid or the lowest live offer in the market.

An error message may be generated if the BSP is out of range. Accordingly, the BSO level should preferably be better than any active bids or offers.

In some embodiments, the BSP may preferably only be validated against firmly posted and subject orders—i.e., orders that are posted for execution subject to fulfillment of a discernable condition. The BSP may preferably not be validated against no-post and held orders.

Sessions involving BSOs may be initiated, updated and/or terminated by brokers directly via a BSO column. In certain embodiments, only brokers that are entitled to manage orders on the interest via desk membership—i.e., affiliation with an entity's trading organization—may manage sessions involving BSOs on the interest.

When a BSO session is initiated, modified or terminated by a broker via the BSO column, the request may preferably be applied immediately to the session.

In some embodiments, sessions involving BSOs may be initiated on any interest regardless of the entity access level of the associated reference entity. In such sessions, the BSO level may be shown in bold font or with another suitable visual indicator(s) of the BSO status.

Steps to manually start, update and end a session involving BSOs follow:

Start Session: a session may start when a broker enters a price in the BSO column and presses <enter>. The BSO level may be updated when a broker updates the price in the BSO order column and presses <enter> on a session in progress.

A BSO session may end once a broker deletes the price in the BSO order column via the <delete> key, clicks the hold icon next to the BSP or selects the delete price option in the right click menu.

In certain embodiments, when a session based on a BSP is in progress on an interest, the interest settings may preferably not be modified via an update credit (or other suitable selection) until the session is stopped.

When a BSS is initiated or the BSO is updated, the BSP may flash for a predetermined amount of time or in a predetermined order. Rules for such flashing are known to those skilled in the art with respect to flashing rules for new prices and price updates. For both new sessions and session price updates, the BSP may flash in yellow or some other predetermined color. The price flash duration may be the same duration as for new prices. Once the BSS is cancelled, the BSP may be cleared from the BSO column. In some embodiments, suggested-levels from broker-suggested sessions may not be stored or captured.

The BSS may terminate, and all related BSOs may be cancelled, when one of the following events happens on the related interest:

Broker or other suitable entity deletes the BSO level;

If a broker deletes the BSO level, the session may end for all users and all open orders may be cancelled; and

Broker updates the BSO level.

If a broker updates the BSO level, the session at the previous BSO may be cancelled and replaced with a new session. All open orders for the previous BSO may also be cancelled. All traders who wish to participate at the new BSO level, may be required to resubmit their orders.

When a posted trade occurs in the market (with or without a work-up session, the work-up session which is explained in more detail below) the BSS may terminate and all open BSOs may be cancelled. The cancellation may occur independent of the price level of the trade. However, in some embodiments, unposted trades may not cancel BSSs.

When a fixing or matching session starts—i.e., a session in which, for example, orders received during a predetermined time period are executed based on some equilibrium price, the equilibrium price which preferably allows the execution of highest volume of the interest, preferably in accordance with price and time priority rules, fixing and matching sessions may be initiated on interests that have BSSs in progress.

It should be noted that in some embodiments, the BSP and/or BSO may be generated manually—e.g., in response to a broker suggestion. In some embodiments, the BSP and/or BSO may be generated based on an externally determined parameter. Such parameter may include a price determined based on a fixing or matching session. The price some equilibrium price, which allows the execution of highest volume of the interest. The price may be some price other than an equilibrium price.

If a fixing or matching session is initiated on an interest with a BSS in progress, the BSS may terminate and all active BSOs may be cancelled.

When the BSO level goes ‘out of range’ due to an improved bid/offer in the market, such as when a posted order is created in the market that is better than or equal to the BSO, the BSS may terminate and all BSOs may be cancelled. The submission of no-post or held orders may preferably not cancel BSSs.

BSSs may terminate when the end of day process runs for the site of the broker that initiated the BSS.

One further aspect of an invention may include the ability to “work up” a trade after the original execution. This may also be known as a join-the-trade (“JTT”) process. The option to enable JTT indicators for the BSSs may be required for broker suggested trading.

“Working up” a trade may include submitting a request to buy or sell additional size of the traded item at the same price of the item that was recently traded in the electronic trading system of the previously executed trade. The “worked up” trade may preferably occur in a separate and timed market in the same system or in another suitable trading system.

It should be noted that the JTT market may be referred to herein as a work up/join the trade market. One difference with respect to the “work up” and “join the trade” aspects of the market is as follows. The original trade participants are referred to as participating in the “work up” and the participants who were not original participants are referred to as participating in the “join the trade.” However, the market of work up and join the trade may preferably be one and the same market—i.e., a market in which the work up/join the trade market buyers and sellers match according to their respective priority.

In one embodiment of the invention, “work up” features may be made available to the users in the same group as the originating users of the execution. Users that were not involved in the execution of the trade may be given “join the trade” optionality or features as will be explained in greater detail below.

In one embodiment of the “work up” feature, any user with semi-interactive or interactive permission type may “work up” the trade. “ViewOnly” and “restricted” permission types may not be able to utilize any of the “work up” features displayed on their respective interfaces.

A further rule associated with “work up” may require an additional level of participation from the semi-interactive or interaction permission type traders. While status as semi-interactive and interactive permission types may be required as a necessary condition to join work-up, nevertheless, if the semi-interactive or interactive users are not signed on to the electronic trading system (or suitable trading application) in which the trade is occurring, at the end of the timer for the worked up trade, then the semi-interactive or interactive users may be denied access to the matching process.

In one further embodiment of the work-up rules according to the invention, the work up feature may suppress an execution pop-up on the interface that is normally displayed after an execution occurs in the electronic trading system or application. Details of the specific execution may appear in a “Live Trade Details” section of the live trade interface provided to users. “Live trade” as used herein refers to the trade that is being worked up following the execution of the original trade.

One further feature of working up trades according to the invention may be that a broker or broker clerk that enters, on behalf of a customer, into a live trade with a certain customer code that was involved in the initial execution will preferably be “working up” the live trade opportunity on behalf of the original code group.

Users not directly involved in the original trade execution may be given the option to “join the trade” during the course of a trade being “worked up.” Join the trade is a feature by which a user submits a request to buy or sell a volume of the interest at the same price, that was recently executed by other users in a separate and timed market in the same or different electronic trading systems and/or applications.

Preferably, only users that have the associated portion of the trading application or system open and operable, said portion (which may be a trading matrix or other suitable trading interface) which may be referred to hereinafter as a “trading screen” or “screen”, may see and/or utilize join the trade features. With respect to the permission types described above, one embodiment of the invention may only allow semi-interactive and interactive to join the trade while view only traders, or other similarly restricted traders or users may not have any of the join the trade features displayed and/or activated on their respective screens.

Similar to work up privileges, any semi-interactive or interactive user may preferably be signed on to the trading system and/or application at the end of the timer to participate in the matching at the conclusion of the live trade.

A broker or broker clerk that enters into the live trade on behalf of a client that was not involved in the initial execution is referred to herein as “joining” the live trade on behalf of the customer association.

With respect to the workflow of a work up/join the trade operation according to the invention, whether based on a BSP, a BSO or a BSS, an execution in a trading system and/or application according to the invention preferably triggers the work up/join the trade feature. Alerts and indicators may be sent preferably substantially immediately to interactive users who have the relevant trading screens open on their trading interfaces.

Following the distribution of the alerts and/or indicators, an application according to the invention may have certain user's prices automatically entered into the live trade.

When original trades are only partially executed, the remaining size may be automatically included in the work up. A live trade window, when displayed on a user's interface, may indicate a current user's live trade status as “worked up” because he still has untraded volume from the original order.

The user may cancel the untraded volume or resubmit a new size prior to the timer for the live trade expiring. Nevertheless, the user associated with the residual volume may not be required to review or respond to the live trade window for the residual size to be included in the work up. Additionally, if the user holds the price using a hold feature—i.e., a feature that allows a user to retain the values of a previously placed order though the held order is not visible or exposed to the market and cannot be traded on without further action on the part of the associated user—while time still remains on the live trade, then automatic work up associated with the residual size may be removed.

In yet another feature of work up/join the trade functionality, prices in the system/application that are equal to the executed price may automatically join the live trade. A user associated with a price that is already in the system and equal to the price of the live trade preferably does not have to review or respond to the live trade window for the size associated with his price to be joined in the live trade. A live trade window, when displayed, may indicate the current user's status as “joined” in the live trade. The user may cancel the order or resubmit a new size prior to the timer expiring. If the user holds the price using the hold option, as described above, then the automatic join with the live trade may be removed.

During the timer countdown of a live trade, users may work up or join the trade. A user may have the ability to modify their respective entry during the countdown to the match of the live trade. However, in some embodiments of the invention, the user may only preferably provide one entry per live trade.

At the end of a specified time interval, a trading application and/or trading system may automatically match up the buyers and sellers that participated in the live trade of the work up/join the trade trading opportunity.

Based on the overall size and direction of the order entered, a single bid/offer may be matched up with multiple bid/offers. Those with priority, which is defined in more detail below, may have their respective entire size matched before moving to the next level of priority. If there is not an equal amount of volume of interest bids to offers or offer to bids, the outstanding size may be thrown out. Once matched, all executed trades may be sent to a suitable trade recordation application or system.

It may be a rule of a trading system according to the invention that outstanding size on both sides may preferably not occur. Instead, only one side of the trade, whether the buy or sell side, may have outstanding size following the match. Alternatively, neither side may have outstanding size following the match.

Following execution, the matched trades may automatically execute in a trading application or system according to the system and, thereafter, trade execution messages may be displayed on relevant user's user interfaces. Rules for sending execution alerts are detailed below in the portions of the specifications relating respectively to interactive trading alerts, interactive trading pop ups, and broker interactive pop ups and emails below.

In one embodiment of the invention, trades executed as part of the live trade may not trigger an additional work up/join the trade feature.

Furthermore, in one embodiment of the invention, only trades executed from relevant, preferably predetermined trading screens may trigger the work up/join the trade feature.

If the remaining, untraded, volume of the interest is not executed as part of the work up/join the trade, the price and partial size may return to be posted on the suitable trading system and/or application. Any additional volume of the interest added by the user, either during the live trade or after the expiration of the timer, may be thrown out. If a partial execution occurs at the conclusion of the live trade, the remaining size may also be returned to the trading system and/or application, similar to the unexecuted remaining size described above. Additionally, if the user decreased the bid or offered amount, the reduced size may be sent back to the trading application and/or the trading system.

In yet another embodiment of the invention, if any remaining volume of the interest is not executed as part of the work up, and the price is “one cancelled other” (OCO)—i.e., if any part of the bid/offer is executed and another part of the bid/offer remains unexecuted, then the systems places the remaining size as a held order—then the price and size may be sent back to the trading application/system in a held state.

Additionally, if a user removed any automatically entered prices from the work up or join the trade, then the prices and sizes may be removed from the application and/or system following the conclusion of the countdown timer.

In yet another embodiment of the system according to the invention, when users add active trading screens to their respective user interfaces during a work up/join the trade, then the new users may or may not receive any additional alerts relating to the work up/join the trade, other than the alerts relating to the indications of the live trade screen. As such, in certain embodiments, the new users may not be able to associate with the ongoing work up/join the trade trading opportunity.

Additionally, in some embodiments of the invention, if the system should cease to function during a work up/join the trade trading opportunity, the work up/join the trade may be cancelled. Users may receive a live trade match status message that indicates that no execution took place.

In another aspect of the invention relating to BSS, some ways for providing settings for a BSS follow:

Such settings may be accessed via interest level defaults;

BSO column right click menu option may be used to implement the appropriate settings;

Entity/Bond Buffet setting (this refers to enabling a sub-set of reference entities or bonds for broker suggested matching. Typically, this is implemented using a yes/no flag); and/or

Such settings may be accessed via a price sheet header, which may apply the setting to all interests in the price sheet.

The following settings/options may be available:

Join Indicator [which indicated a default join capability]

Join Direction [which indicates a default join direction]

Trade indicator (Boolean, since trades are executed in real time and there is no BSS timer).

In certain embodiments, one, some, or all join and trade indicator settings may be disabled by default.

All settings may persist for the interest if the interest is modified—i.e., if the price on the BSS is updated.

Since BSSs are initiated at the interest level, BSS settings may apply to all instances of the interest regardless of the price sheet in which the session is initiated.

Join indicators may be shown in the “BSO” column when a site, other than the broker, joins the BSS.

Direction-based join indicators may be shown in the Buy Size and Sell size column, depending on the direction of outstanding join requests, or in any other suitable location on a trading GUI.

Trade indicators are shown in the “BSO” column when trades are executed in the BSS by non-trading group members. Such trades may include trades from other traders within the same site. If the trading group does not have share trades enabled, then the trade indicator is shown when a trading group member trades.

The simultaneous display of join and trade indicators may also be supported in the BSO column.

Join and trade indicator support may be provided in the BSO field of the price sheet.

If the join indicator is triggered, the background of the BSO field may be displayed in a suitable font color. If the trade indicator is triggered, the background of the BSO field may be a second suitable color.

If both join and trade indicators are triggered, the background of the BSO field may be formed from half of the first suitable color and half of the second suitable color, or from some other suitable combination of colors or other visual indicators.

Once the BSS ends or a new BSS is triggered, join and trade indicators may be removed from the BSO field.

Traders that are entitled to participate in matching sessions on the interest via their “desk trader entitlement” role may be entitled to participate in BSSs on the interest. Such a trader should preferably have one of the following desk trader roles: Interactive Trader, which enables the trader to view enter and execute prizes for the interest; Fixer, which enables the trader to participate in the Fixing portion of a matching session; and Joiner, which enables the trader to join the trade during the course of a trade being worked up. Accordingly, such a user may submit a request to buy or sell size at the same price for an interest that was recently executed in the same or a different market by other trades.

Traders that have view-only entitlements on the interest may be permitted to view the broker-suggested-level in the BSO column, but may not be permitted to submit orders in the BSS and access to the BSO submission dialog may be disabled.

If interest access level is set to view-only or semi-interactive, traders may be permitted to participate in BSSs on the interest as long as the trader is entitled via desk entitlements.

Orders for BSSs may preferably only be submitted and updated by entitled traders and/or brokers via a new order entry dialog.

Access to the order entry dialog by traders may be via the BSO column on the trader's price sheet.

The dialog may be accessed by double clicking on the price in the BSO column.

A right click menu option may be available via the BSO column, with a “BSO” option, which may open the BSO entry dialog. The order entry dialog may only be accessible when a BSS is in progress. In some embodiments brokers may not have access to the order entry dialog for BSSs. The BSO column may provide the ability to cancel BSOs via a hold icon, but the creation and update of orders should preferably be submitted via the dialog.

The order entry dialog for BSSs may allow traders to submit buy and sell requests at the broker specified BSO-level.

Timer—The timer column may display static text “BSS” when the session is in progress.

Once the session ends, the ended timestamp may be displayed.

The BSO column may also be used to display join and trade indicators if the setting is enabled.

In some embodiments credit details, or details of another suitable interest, may be the same as for a conventional matching dialogue box, and trading group functionality may be supported.

A buy size field may be used to display direction based join indicators related to buy requests.

A BSO, according to the invention, may show the BSP level specified by the broker via the BSO column in the price sheet.

Traders may submit their size either via the size entry field or size buttons, depending on their user preference setting.

In certain embodiments, traders may only be permitted to submit orders at the broker specified level and may not be permitted to enter their own levels.

The status field and trade summary table may notify traders of trade execution details.

In some embodiments of the invention, BSO tracking may be limited in that only a single BSO entry dialog may be opened at one time.

Opening the BSO entry dialog for a different interest may close an open BSO dialog, as long as the dialog for the new interest remains open. The BSO entry dialog may only show details for a single interest at a time.

In some embodiments, the BSO entry dialog may not automatically pop up when the BSS is initiated or ended. Therefore, traders may be required to open the dialog manually. Additionally, the BSO entry dialog may not automatically popup when the trader's submission trades.

A BSO entry dialog according to the invention may have no timer, and the session may preferably only end when a broker manually deletes the broker-suggested-level via the BSO column.

The following user settings, defined at least in part via the preferences menu of the client, may apply to the BSO entry dialog:

a. Live Trade: Always on top

b. Show Live Trade Size buttons

c. Show submitted amount in status

d. Matching/Live Trade order confirmation

All BSOs should preferably be submitted via the BSO entry dialog. Nevertheless, traders may be permitted to maintain market orders and BSOs simultaneously on a single interest.

If a trader that has a BSO enters a market order that crosses with the BSS level, the rules for handling crossed broker suggested levels may apply and the BSS may be terminated.

When a trader has an order in a BSS, the BSP may be displayed with a background of a first suitable color.

If the BSO is a bid, the BSP may be displayed in a second suitable color. Further, the trader may see a hold icon to the left of the BSP.

When his BSO is an offer, the BSP may be displayed in a third color, and the trader may see a hold icon to the right of the BSP (A different color may be needed, since the first color may conflict with the Join the Trade indicator.)

A right click menu option may be available with a “cancel BSO” option, which may cancel the outstanding BSO. The size of the BSO may not be visible in the price sheet. The BSO hold icon may be available regardless of whether the trader has in-cell icons enabled or disabled.

The background and font coloring of the BSO may be visible to the trader that owns the order, as will all traders from the trader's site and/or group.

In some embodiments, only the trader that owns the order and traders from the trader's trading group that shares trades may have access to the hold icon and the right click.

A “Hold BSOs” button may be available in the button bar of the trader client, which may hold all of the trader's BSOs. Unlike existing “hold all” buttons, there may only be a single “hold BSOs” button, which may apply to all BSOs in both Credit Derivative Swap (“CDS”) and Investment Grade Bond (“IGB”) product lines.

A trader's timer may apply to all the trader's BSOs in addition to his regular market orders. Once the trader's timer expires, all of the trader's market orders may be held and all BSOs may be cancelled. If the trader's timer is refreshed—e.g., reset to an initial setting —by the trader or a broker on the trader's behalf, the timer for outstanding BSOs may also be refreshed.

If OCO (one cancels the other) is triggered, BSOs may be held along with the trader's market orders if the BSO meets the trader's OCO conditions —i.e., hold by product line, hold by sector, hold all orders, hold by side.

BSS trade executions may be included in the trader's OCO count and may trigger OCO if OCO conditions are met.

### Example

ABC Trader has OCO set to be triggered if the trader trades 2 times in 5 minutes, and hold by sector and hold by side are enabled.

ABC Trader has three market bids and three market offers in price sheet EU Tobacco.

ABC Trader has three BSOs to buy and three BSOs to sell in EU Tobacco.

Two of ABC Trader's market bids are executed within 5 minutes of one another.

ABC Trader's remaining market bid order and all three of ABC Trader's BSS buy orders are cancelled.

ABC Trader's offers and BSS sell orders are not held.

In another example, two of ABC Trader's BSS sell orders are traded within 5 minutes of one another.

OCO is triggered and ABC Trader's bids and remaining BSS sell orders are held.

Interests on which there is an active BSS in progress may be treated as if there is a firm posted order on the interest in terms of applying a user's show live settings. Once the BSS ends, the interest may be hidden if the user has “show live” enabled and there are no active orders or trades on the interest.

Termination of the BSS or the update of the BSO price level may cancel the BSO. Traders that have outstanding BSOs may be alerted when their BSO is cancelled. Only traders that have outstanding BSOs may receive the alert.

The format of the alert message displayed may depend on whether the session was cancelled due to a session cancellation or session update—i.e., whether the broker stops the session, or the session ends due to a trade against a broker position updating the BSO level. Two exemplary cancellation message formats follow:

1) Cancellation message: <Ended Date+Time><Credit Name> BSS ended. Order to <Buy/Sell><Size>@<Price> canceled.

2) Cancellation due to update message: <Date+Time><Credit Name> BSS updated to <New BSP>. Order to <Buy/Sell><Size>@<Price> canceled. Please resubmit your order.

If the BSS ends due to the broker suggested level crossing with a market order, the cancellation alert may be generated in addition to the trade execution dialog.

The user interface and interaction of the alert dialog may be the same as the counter and trade alert dialog.

Like standard Matching and Fixing sessions, trading group functionality may be applicable to BSSs. For example, a trader's BSO may be visible to the trader that owns the order, and other traders from the trader's trading group. Also, the BSO entry dialog may show outstanding order and trade details related to orders submitted and trades executed by other traders from the logged-in trader's trading group.

In certain embodiments, group functionality may provide that all trading group members that share trades, may share a single buy/sell request on an interest. Group functionality may also provide that all trading group members may be permitted to manage the trading group's orders.

Traders from the same site/institution that are not part of a trading group may not see order and trade details in the BSS order entry dialog.

Once a trade is executed, the trade details may be viewed by group members via the trade logs.

A trader may edit an existing BSO by double-clicking on the related BSP. This may bring up the BSO dialog populated with the trader's existing order size. The trader may then modify the side and/or size as desired.

A trader may cancel a BSO by clicking on the red X icon next to the related BSP.

Brokers may not see any indication that a trader has an outstanding BSO in the market. Price/Trade log messages may not be generated for brokers or traders when a trader submits, updates or cancels a BSO.

Preferably, brokers may only receive trade execution messages in trade logs. Broker trade log messages for BSS trades may have a “G”, or other suitable indicator, pre-pended to the size.

For users with predefined support roles that also have show matching information enabled on their user profile, BSO submissions by traders may generate “joins”, “cancels” and “unfilled” trade log messages in real time.

There may be no reserved phase for BSSs. Counterparty restrictions may be enforced for broker suggested trades. Clearing restrictions may be enforced for broker suggested trades. All trades may be executed in real time.

Unlike trades executed in other settings, trades executed in BSSs may be completed immediately. Furthermore, trades may be sent to trade capture systems immediately. Trade tickets and trade log messages may be generated immediately.

Counterparty information may be provided immediately in the BSO entry dialog trade summary table and trader trade logs.

In certain embodiments, trades are completed as they are filled. In such embodiments, trade aggregation may not be possible. Therefore, if multiple trades are executed against the same counterparty at the same price for the same BSS, a trade ticket may be created for each execution.

In certain embodiments, buyers and sellers in the BSS may be instantly matched based on time priority.

Time priority determination rules may be as follows: price and size updates resets time priority, while size updates do not reset time priority.

Orders that are partially filled may remain tradable and active until the remaining size is cancelled or filled in full. When a BSO is executed, the BSO entry dialog may not automatically open.

When a BSP goes out of a trading range—e.g. when the regular market on the interest is quoted with a bid or offer that is better than the BSP—the following may occur:

The BSS may be terminated;

Any standing BSOs may be checked for a potential match with the improved market order that triggered the ‘out of range’ condition—i.e., system may check clearing and counterparty restrictions for the two sides;

If the BSO qualifies for a potential posted trade with the opposite side market order, then the owner of the BSO may be alerted via a special trade dialog, and be provided an option to do a posted trade by hitting/lifting the matching regular market bid/offer, which may then trigger a JTT session;

If the BSO does not qualify for a potential trade with the opposite side market order, then the BSO may be cancelled and the owner of the BSO may not be presented with the option to trade;

In the event that two or more of such broker suggested trade opportunities arise concurrently, a trade execution dialog may be presented to the trader, via which the trader can view and respond to all potential trades in a single window;

Each potential trade may be displayed in a separate row with the credit, or other suitable interest, name, a hit/lift button showing trade direction, size and price, and status;

The trader may click on the desired hit/lift button to execute the trade;

If JTT is enabled for the interest, then workup may be initiated in response to the trader with the crossed BSO election to execute the order in the market;

All trades initiated via the trade execution dialog for crossed BSOs may be at the price of the order in the market —i.e., the execution may be the same as if the trader with the BSO hit/lifted the order on screen via the conventional hit/lift dialog; and

All trades initiated via the trade execution dialog for crossed BSOs may occur for the size of the posted order in the market, regardless of the size of the trader's BSO, and the trader may be required to workup any additional size he/she wishes to trade —i.e., the electronic trading system may not auto-workup any amount from the BSO that is greater than the size of the market order.

The following is an example in which BSO matches a posted trade:

Market is 70 bid-75 offer;

Interest has JTT enabled;

T1 has the 70 bid in the market;

T2 has the 75 offer in the market;

BSP is 72;

T3 enters a broker suggested offer at 72;

T4 also enters a broker suggested offer at 72;

T3 and T1 cannot trade with each other due to clearing restrictions;

T1 improves his market bid to 72;

BSS is terminated;

T3's broker suggested offer is terminated;

T4's broker suggested offer is also terminated, but he receives an alert with the option to do a posted trade with T1 at 72; and

If T4 submits the trade the trade between T1 and T4 is executed and JTT starts.

If a trade occurs when a price improvement in the regular market triggers an auto-match, the regular market order may be given priority even when there is a more aggressive BSO.

The following is an example in which auto-match bypass is a more aggressive, crossed, BSO:

### Example

Market is 70 bid-73 offer.

Interest has auto-match and JTT enabled.

T5 has the 70 bid in the market;

T6 has the 73 offer in the market;

BSP is 72;

T7 enters a broker suggested offer at 72;

T8 attempts to enter a market bid of 73;

This triggers an auto-match, and T8 receives a message telling him that submitting that bid may result in a trade;

If T8 accepts the trade and continues:

T8 trades at 73 with T6, and JTT starts;

BSS is terminated;

T7's broker suggested offer of 72 is terminated;

If T8 cancels and declines the trade:

T8's bid is not submitted;

BSS remains active.

When a trader's BSO crosses with a market order, the trader with the BSO may be notified of the possible trading opportunity via a trade execution dialog for crossed BSOs.

A trade execution dialog box for crossed BSOs may be generated for a trader if the trader's BSO meets the following conditions:

Trader's BSO should preferably be on the opposite side of the market order —i.e., if market order is a bid, then trader's crossed BSO should preferably be a sell request, otherwise the trader with the BSO is not given the option to trade.

Trader with the BSO should preferably not be counterparty-restricted with the initiator of the market order.

Trader with the BSO should preferably not be clearing restricted with the initiator of the market order.

The order that crossed with the trader's BSP should preferably not be locked for clearing.

The order that crossed with the trader's BSP is preferably not from the trader's institution.

There should preferably not be correlation restrictions for the trader with the BSP—e.g., German banks are not permitted to sell protection on German Bank names.

The outstanding size of the BSO may be ignored, in that the trader with the BSO may be given the option to trade the market order for the market order's size, regardless of whether the size of the BSO is greater or less than the size of the market order.

In certain embodiments of the invention, Financial Information eXchange Protocol (“FIX”) users may not receive the trading opportunity message in the case of crossed BSO events.

As a general rule the trade execution dialog for crossed BSOs may only reflect the state of the market when the crossed market was generated and may not be updated to reflect any changes to the market.

Certain embodiments of the invention may only display a color-coded—e.g., red for hit, and blue for lift-trade execution button with the direction, size and price details of the best order only. Only the best order may be traded even if there are orders in depth at the same price level —i.e., deal by volume may not be permitted. The ability to partially trade the crossed market order may be available if the size of the market order is greater than the standard size.

If the trader clicks the trade execution button within the dialog, the related panel may close and the JTT session may initiate if JTT is enabled.

If the trader has the dialog open and orders are created on other interests, which cross with other BSOs belonging to the trader, additional panel rows may be added to bottom of the execution dialog with, for example, the oldest panel on top.

If multiple trading opportunities are available, the dialog may remain open after one panel is closed due to a trade or the user closing a single panel.

If there are no additional trading opportunities available, the dialog may close automatically.

Once the dialog is closed, trading opportunities presented in previous instances of the crossed order trade execution dialog may not be presented again if the dialog reopens in response to new market events.

Once the dialog is generated by a crossed order event, the dialog may not be refreshed to reflect subsequent market updates on the corresponding interest.

If there are changes in the market prior to the trader submitting the trade request and the system is unable to execute the trade, the trade request may fail, the hit/lift button may be disabled and an error message may be displayed in bold red in status field.

If the order is no-longer tradable, the following message is displayed: Market conditions have changed.

If the interest is locked, the following message may be displayed: Sorry, another trade is in progress.

If the trade request fails, the trader may close the dialog or panel and there may be no option to refresh.

The trade request processing rules may be the same as the standard trader hit/lift dialog.

The following events may be considered “Market conditions have changed” validation events:

no firm posted orders exist that are at the quoted price level or better;

all orders at the quoted price level or better are counterparty-restricted;

all orders at the quoted price level or better have become subject to other trading events; and

the order is locked for clearing.

The following events may be considered “Sorry, another trade is in progress” validation events.

broker has hit/lift dialog open on the order;

workup session is in progress; and

An error on is enabled.

If a Matching or Fixing session is initiated on the interest prior to trade request submission, then the interest is locked for matching error message may be generated (same workflow as standard hit/lift dialog).

Expanding rules for handling trade executions according to certain embodiments may be as follows:

All trade processing and validations may be applied against the orders that are available when the trader with the crossed BSO submits the hit/lift request; and

All trades executed via the dialog may be posted trades and follow-on workup sessions may be initiated if enabled for the interest.

If the system is able to execute the trade at a price equal to or better than the price quoted in the trade execution dialog, the trade may be executed at the best price available. The trade may fail if the price is worse than quoted price.

### Example

ABC's broker-suggested offer crosses with MS's market bid of 5 MM@100;

Prior to ABC submitting a hit request via the crossed order trade execution dialog, MS improves the bid to 5 MM@101; and

ABC submits the hit request and the trade is executed with MS for 5 MM@101.

Counterparty

The counterparty that owns the order in the market may be disregarded in executing the trade as long as the price requirement is satisfied and there are no counterparty-related restrictions.

### Example

ABC's broker suggested offer crosses with MS's market bid of 5 MM@100;

Prior to ABC submitting a hit request via the crossed order trade execution dialog, GS enters a better bid of 5 MM@101; and

ABC submits the hit request and the trade is executed with GS for 5 MM@101.

The system may attempt to execute the trade for the full-quoted size requested by the trader.

The system may execute orders in depth to fulfill the quoted size, if the orders in depth have a price equal to or better than the quoted price.

### Example

ABC's broker suggested offer crosses with MS's market bid of 10 MM@100;

Prior to ABC submitting a hit request via the crossed order trade execution dialog, MS updates the size of the bid to 5 MM@100;

GS joins the best bid for 5 MM@100; and

ABC submits the Hit request and the trade is executed with MS for 5 MM@100 and GS for 5 MM@100.

The traded size may preferably never be greater than the size shown in the trade execution dialog.

If the available size of the best order is greater than the size of the quoted size, the best order may be partially traded and the remainder may automatically be worked up if JTT is enabled.

### Example

ABC's broker suggested offer crosses with MS's market bid of 5 MM@100;

Prior to ABC submitting a hit request via the crossed order trade execution dialog, MS updates the size of the bid to 10 MM@100;

ABC submits the hit request and the trade is executed with MS for 5 MM@100; and

MS's remaining 5 MM size is auto-worked up.

If the available size is less than the quoted size, the system may execute the available size and the remainder may automatically be worked up if JTT is enabled.

### Example

ABC's broker suggested offer crosses with MS's market bid of 10 MM@100;

Prior to ABC submitting a hit request via the crossed order trade execution dialog, MS updates the size of the bid to 5 MM@100;

ABC submits the Hit request and the trade is executed with MS for 5 MM@100

ABC's remaining 5 MM size is auto-worked up.

If the size of the market order is greater than the standard size, then the trader with the BSO may be permitted to partially trade the market order.

When the market order is partially traded, the remainder may automatically be worked up in the Live Trade session.

### Example

ABC's broker suggested offer crosses with MS's market bid of 50 MM@100;

Standard size is 5 MM;

ABC partially hits MS's bid for 5 MM; and

MS is automatically worked up to buy 45 MM in a live trade session.

If multiple traders with outstanding BSOs are crossed with a market order, each trader that qualifies to execute the market order may be presented with the trading opportunity.

All executions via the crossed order trade execution dialog may be on a first-come first-served basis, and order ranking from the BSS may not apply.

If JTT is enabled on the interest, only the first trade request submission may be accepted and subsequent trade request submissions may be rejected if the request is received while the JTT session is in progress.

### Example

BSS is in progress on DT 5 y at a price of 100;

ABC submits a BSO to buy 10 MM;

KITI submits a BSO to buy 10 MM;

MS enters an offer in the market for 10 MM@99;

ABC and KITI are both presented with the trading opportunity; and

KITI responds first and lifts the offer via the crossed trade dialog and JTT is initiated;

ABC attempts to lift the offer via the crossed trade dialog and the trade request is rejected.

If JTT is disabled on the interest, or subsequent trade requests are received after the JTT session is ended, the system may execute the trade request if there is market depth that fulfills the price and size conditions request.

### Example 1

BSS is in progress on DT 5 y at a price of 100;

ABC submits a BSO to buy 10 MM;

KITI submits a BSO to buy 10 MM;

MS enters an offer in the market for 10 MM@99;

ABC and KITI are both presented with the trading opportunity;

KITI responds first and lifts the offer via the crossed trade dialog and JTT is initiated;

MS works up to sell 10 MM more but is unfilled;

MS has post unfilled enabled and an offer is created in the market for 10 MM@99;

After the JTT session ends, ABC clicks lift via the crossed trade dialog; and

Trade is executed between ABC and MS for 10 MM@99, and JTT is once again initiated.

### Example 2

JTT is disabled;

BSS is in progress on DT 5 y at a price of 100;

ABC submits a BSO to buy 10 MM;

KITI submits a BSO to buy 10 MM;

MS enters an offer in the market for 10 MM@99;

ABC and KITI are both presented with the trading opportunity to lift the 10 MM@99 offer;

GS enters a better offer in the market for 10 MM@98.5 before ABC and KITI respond;

KITI responds first and lifts the offer and the trade is executed with GS for 10 MM@98.5; and

ABC responds second and is matched with MS for 10 MM@99.

In certain embodiments of the invention, the crossed order trade execution dialog may only show one order per interest even if there are multiple orders at the best price level.

Traders may not be permitted to directly submit deal-by-volume executions via the crossed order trade execution dialog. However, if there are changes in the market prior to trade execution, the system may attempt to execute orders in depth to fulfill the initial size quoted if orders in depth are available and fulfill the price and counterparty criteria.

If the best price that initially crossed with the trader's BSO is cancelled or updated to a worse price, then any trade requests may be rejected if there are no orders in depth that fulfill the price and counterparty criteria.

If the best order in the market becomes a restricted order, the system may attempt to execute the trade with any non-restricted orders in depth that meet price and size requirements.

### Example

GS is counterparty-restricted with ABC;

ABC's broker-suggested offer crosses with MS's market bid of 5 MM@100;

Prior to ABC submitting a hit request via the crossed order trade execution dialog, GS enters a better bid of 10 MM@101;

ABC submits the hit request and the trade is executed with MS for 5 MM@100, bypassing GS's restricted bid; and

GS's bid is auto-worked up to buy 5 MM@100.

Trades executed via BSSs may preferably be reported to trade capture systems (CTC CTC-2842 and BTC BTC-2930) substantially immediately as trades are executed during the session. Thus, in certain embodiments, a trade executed, at least in part, in response to a “broker suggested” price—e.g., a trade between an unposted bid submitted in response to a broker suggested offer and a posted offer, or a trade between an unposted offer submitted in response to a broker suggested bid and a posted bid, is still a trade and should preferably be sent to the trade capture system (CTC for CDS trades and BTC for bond traders) for enrichment, final confirmation and straight through processing (“STP”).

Trades may be flagged as BSS trades via a new trade source, which may be sent to CTC and BTC in the trade message. In certain embodiments, all BSS trades may be characterized as no-post trades. In certain embodiments, all BSS trades may be characterized as posted trades. In certain embodiments, all BSS trades may be characterized as electronic trades. Both sides of a BSS trade may be considered aggressors.

There may be no indication in trade STP messages that a trade was executed via BSSs. BSOs may not be sent to price API. FIX may not support BSSs. FIX users may not receive the trading opportunity message in the case of crossed BSO events.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

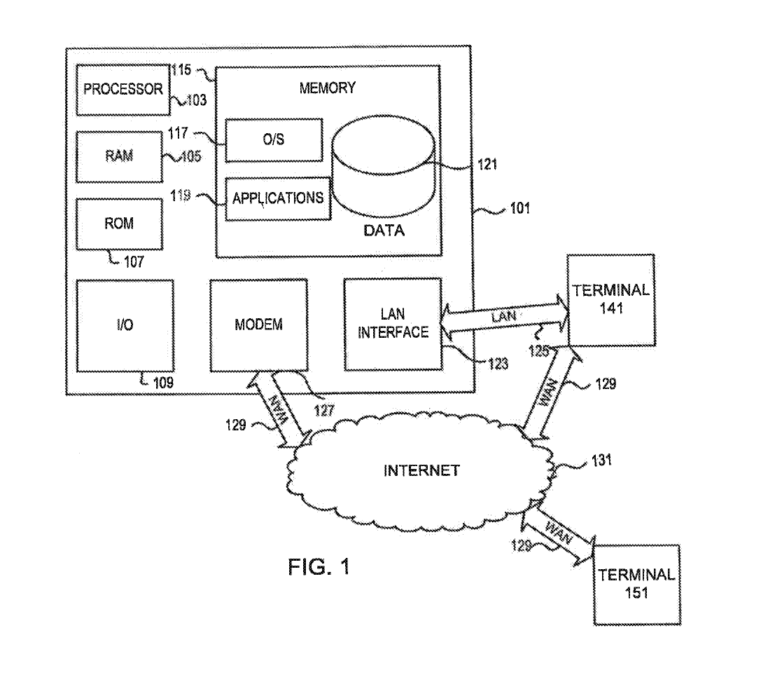

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 111 may provide storage for records of trades based on broker suggested bids and broker suggested offers, attempts to act upon broker suggested trades, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Data related to coupon offers, data related to broker suggested trading and any other suitable information may be stored in memory 115.

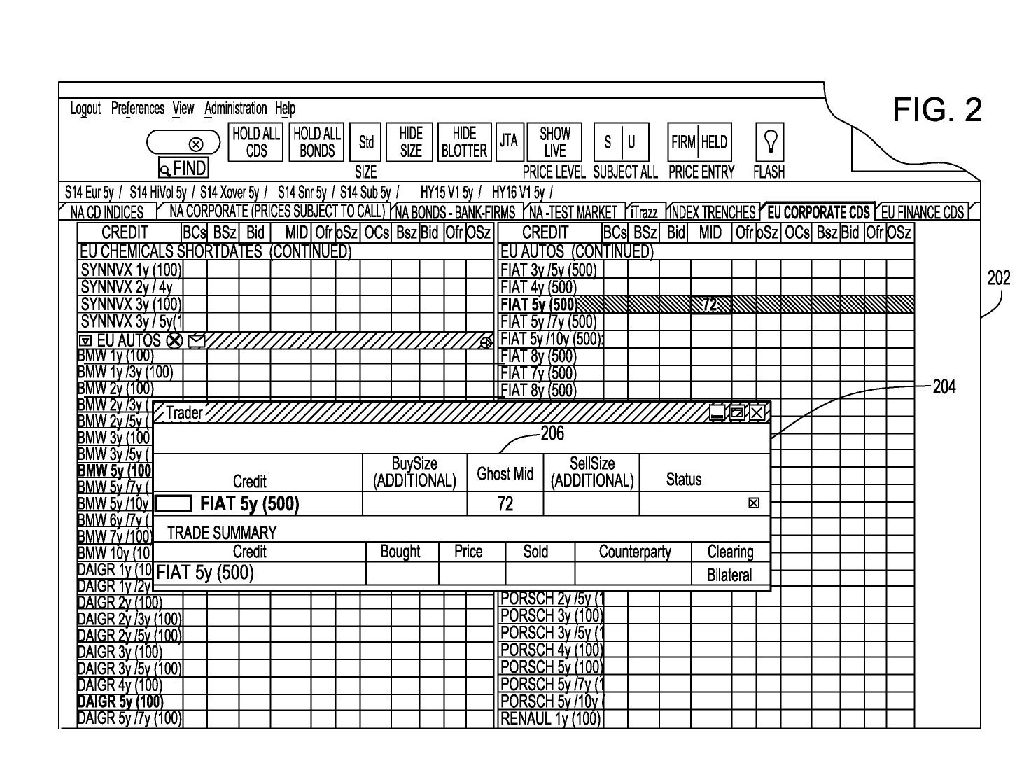

FIG. 2 shows an exemplary user interface 202 for use with systems and methods according to the invention. User interface 202 preferably includes line 204.

When a user selects line 204, a broker suggested trader trade execution dialog box 206 may be displayed to a user. Box 206 may preferably include a live broker suggested trade portion.

The live broker suggested trade portion may include a broker suggested mid price field 208, a credit (or other financial interest or instrument) identification field 210, a buy size 212 (ADDITIONAL) field 212, a sell size (ADDITIONAL) field 214, and/or a trade status field 216.

Box 206 may also include a trade summary portion 218. Trade summary portion may include an amount bought field 220, a price field 222, an amount sold field 224, a counterparty field 226 and/or a trade method toggle field 228. Toggle field 228 may toggle between clearing and bilateral.

In some embodiments of the invention, a trade in which a BSP has been posted may be displayed as a mid price in GUI 202 (see price 205). Upon selection of line 204, box 206 may be displayed. Box 206 may display that price 208 is in fact a BSP. As such, a user other than the trader who entered the BSP may understand that the BSP is only a bid, offer, or trade for display to a market. The user may understand that the bid, offer or trade does not reflect a tradable interest. Rather, the BSP represents a possible trading position which is, however, not executable.

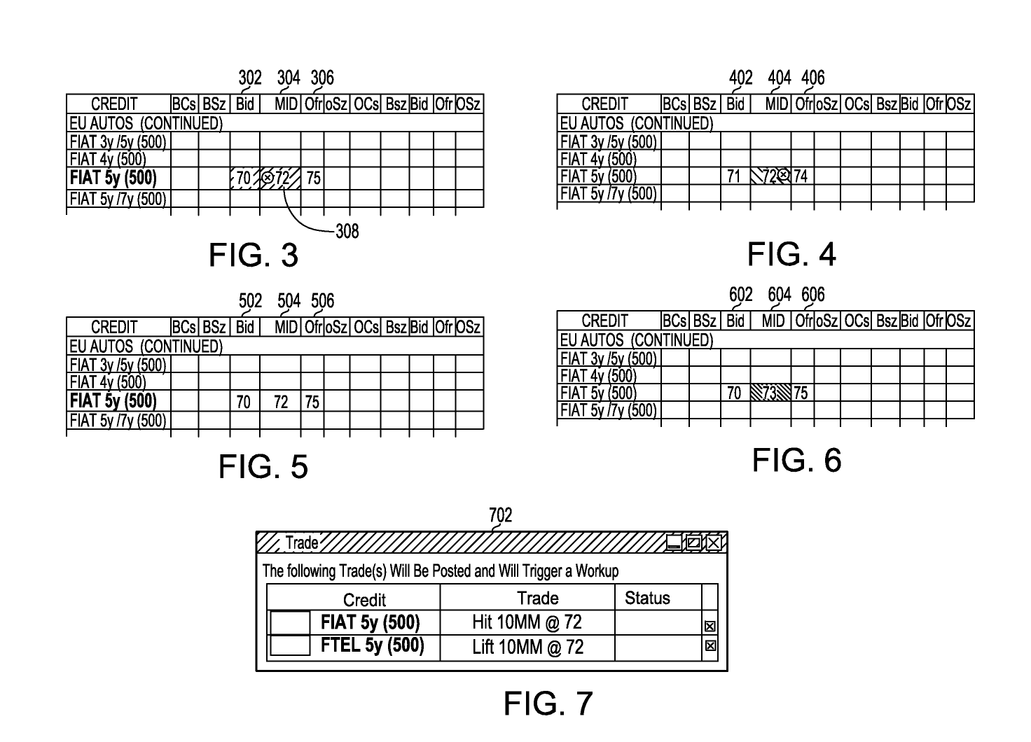

FIG. 3 shows a second GUI for use with systems and methods according to the invention. FIG. 3 shows, inter alia, a bid price 302, a mid price 304 and an offer price 306. The buy price 302 may represent the current tradeable buy price. The sell price 304 may represent the current tradeable sale price. The mid price 306 may represent either a true mid price, which may be obtained via a fixing session and which may form the basis of a mid-price auction, or a BSP, which one of the traders entered and which does not reflect a tradeable price. The shading of the “70” indicates that the trader (FIG. 3 shows the trader's view) has an active BSP of “70”. The “X” icon on the left of the price indicates that the BSP is a bid to buy.

Such a BSP may be displayed with a red X 308 to the left of mid price 304, or an X of another suitable color. In certain embodiments, a trader may cancel a BSO by clicking on the red X icon next to the related BSP.

FIG. 4 shows a third GUI for use with systems and methods according to the invention. FIG. 4 also includes a bid price 402, a mid price 404 and an offer price 406. The “X” icon on the right of the mid price indicates that the BSP is an offer to sell.

FIG. 5 shows a fourth GUI for use with systems and methods according to the invention. FIG. 5 includes columns 502, 504 and 506. In FIG. 5, none of columns 502, 504 and 506 are shaded. FIG. 5 shows the trader's view of an active BSS (with the column being populated at 72) where the viewing trader has not submitted any BSOs.

FIG. 6 shows a fifth GUI for use with systems and methods according to the invention. FIG. 6 includes columns 602, 604 and 606. In certain embodiments, this can be the starting point of the BSS for a trader that enters a nopost order, where another party has submitted a broker suggested bid or a broker suggested offer.

FIG. 7 shows a sixth GUI for use with systems and methods according to the invention. FIG. 7 occurs at the point described above where the owner of the host price can be matched against a posted order; thereby generating a posted trade and, if enabled, a JTT session.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus it has been shown that systems and methods for implementing trading based on broker-suggested pricing have been provided. One skilled in the art may appreciate that the present invention can be practiced by other than the described embodiments, which are presented for purposes of illustration rather than of limitation, and the present invention is limited only by the claims which follow.

What is claimed is:

1. A financial instrument transaction system comprising:
a database configured to store financial instrument information for certain reference entities;
memory configured to store execution instructions; and
a processor coupled with the database and the memory, the processor configured to execute the instructions, the instructions configured to cause the processor to:
receive from a first broker client trading instructions associated with a reference entity, the instructions that include either a buy or sell position and a price, the buy or sell position not for display to other broker clients;
in response to a trade command from one of a plurality of other broker clients, said trade command that comprises a counter order to the buy or to the sell position, sending an electronic notification to the first broker client associated with the buy or sell command that the one of the plurality of broker clients has, at least in fact, submitted a counter order that comprises an order that is capable of executing a trade with the first broker's buy or sell position.

2. The system of claim 1, querying the first broker whether he wishes to execute a trade with the counter order.

3. The system of claim 2, wherein, if the first broker responds positively to the query from the system, executing a trade between the buy position or the sell position and the counter order.

4. The system of claim 2, wherein, if the first broker fails to respond positively to the query from the system, delete the buy position or the sell position from the system.

5. The system of claim 4, further comprising notifying the first broker that the buy position or the sell position has been deleted from the system.

6. A financial instrument transaction system comprising:
a database configured to store financial instrument information for certain reference entities;
memory configured to store execution instructions; and
a processor coupled with the database and the memory, the processor configured to execute the instructions, the instructions configured to cause the processor to:
receive from a first broker client trading instructions associated with a reference entity, the instructions that include a buy command and a price, the buy command not for display to other broker clients;
in response to a trade command from one of a plurality of other broker clients, said trade command that comprises a counter order to the buy command, sending an electronic notification to the first broker client that the one of the plurality of broker clients has submitted a counter order that comprises an offer that includes the same price as the buy command.

7. The system of claim 6, querying the first broker whether he wishes to execute a trade with the counter order.

8. The system of claim 7, wherein, if the first broker responds positively to the query from the system, executing a trade between the buy command and the counter order.

9. The system of claim 7, wherein, if the first broker fails to respond positively to the query from the system, delete the buy command from the system.

10. The system of claim 9, further comprising electronically notifying the first broker that the buy command has been deleted from the system.

11. A financial instrument transaction system comprising:
a database configured to store financial instrument information for certain reference entities;
memory configured to store execution instructions; and
a processor coupled with the database and the memory, the processor configured to execute the instructions, the instructions configured to cause the processor to:
receive from a first broker client trading instructions associated with a reference entity, the instructions that include a broker suggested price, the broker suggested price for display to other broker clients;
receive from a second broker client trading instructions associated with the broker suggested price, the instructions that include a buy command at the broker suggested price, the buy command not for display to other broker clients;
in response to a trade command from one of a plurality of other broker clients, said trade command that comprises a counter order to the buy command, sending an electronic notification to the second broker client that the one of the plurality of broker clients has submitted a counter order that comprises an offer that includes the same price as the buy command.

12. The system of claim 11, querying the second broker whether he wishes to execute a trade with the counter order.

13. The system of claim 12, wherein, if, in response to the querying, the second broker instructs the system to execute a trade with the counter order, executing a trade between the buy command and the counter order.

14. The system of claim 11, wherein, if the second broker fails to instruct the system to execute the trade in response to the querying from the system, deleting the buy command from the system.

15. The system of claim 9, further comprising electronically notifying the second broker that the buy command has been deleted from the system.
